(19) United States
(12) Patent Application Publication
(10) Pub. No.: US 2011/0200406 A1
(43) Pub. Date: Aug. 18, 2011

(54) MACHINING INSTALLATION FOR WORKPIECES

(75) Inventors: Heiner Lang, Pforzheim (DE); Waldemar Haus, Winnenden (DE)

(73) Assignee: MAG EUROPE GMBH, Goppingen (DE)

(21) Appl. No.: 13/027,693

(22) Filed: Feb. 15, 2011

(30) Foreign Application Priority Data
Feb. 18, 2010 (DE) 102010002128.8

(51) Int. Cl. B23Q 16/00; B23C 3/00

(52) U.S. Cl. 409/174

(57) ABSTRACT

A machining installation comprises a workpiece positioning device with a workpiece holder pivot unit which is designed in such a way that a workpiece holder, together with a workpiece to be machined, is pivotable about at least five pivot axes. In order to rotatably drive a tool about an axis of rotation, a work spindle unit is arranged at a stand, with the axis of rotation being inclined relative to a horizontal x-direction through an angle α, with 20°≦α≦70°, particularly 30°≦α≦60°, and particularly 40°≦α≦50°. The machining installation has a simple design and allows a flexible five-sided machining of workpieces.

### BACKGROUND OF THE INVENTION

1. Field of the Invention

The invention relates to a machining installation for workpieces, particularly for machining workpieces of metal or workpieces of fibre-reinforced composites.

2. Background Art

WO 2010/000 457 A1 discloses a machining installation for workpieces comprising a workpiece positioning device and an associated tool positioning device. The workpiece positioning device comprises a workpiece holder pivot unit which is designed in such a way that a workpiece holder is pivotable about three or four pivot axes. The associated tool positioning device comprises a tool holder pivot unit which is designed in such a way that a work spindle unit is pivotable about one or two pivot axes.

### SUMMARY OF THE INVENTION

It is the object of the invention to provide a simply designed machining installation which allows a flexible and precise five-sided machining of workpieces. This object is achieved by a machining installation for workpieces, comprising a workpiece positioning device for positioning a workpiece to be machined, comprising a base frame; a workpiece holder; and a workpiece holder pivot unit which is arranged between the base frame and the workpiece holder and is designed in such a way that the workpiece holder is pivotable about at least five pivot axes; and a work spindle unit for rotatably driving a tool about an axis of rotation, the work spindle unit being arranged at a stand in such a way that the axis of rotation is inclined through an angle α relative to a horizontal x-direction, with 20°≦α≦70°, particularly 30°≦α≦60°, and particularly 40°≦α≦50°.

As the workpiece positioning device comprises a workpiece holder pivot unit having at least five pivot axes, workpieces to be machined can be picked up, positioned for machining and subsequently be deposited using the workpiece positioning device. The workpiece positioning device is for example a robot or industrial robot. The axis of rotation of the work spindle unit is inclined through an angle α relative to a horizontal x-direction, with the angle α being in the range of 20° to 70°, particularly of 30° to 60°, and particularly of 40° to 50°. The angle α is advantageously equal to 45°. As the work spindle unit is arranged at the stand at an angle to the workpiece positioning device, a five-sided machining of the workpieces is possible in conjunction with the at least five pivot axes of the workpiece positioning device. Moreover, the rigid, in other words non-pivotable and inclined arrangement of the work spindle unit on the stand allows the total number of pivot axes to be kept to a minimum. As a result, the machining installation has a simple design, which in turn optimizes the costs.

The machining installation is particularly suitable for automated machining of workpieces having a maximum size of approx. 200 mm×200 mm×200 mm and a maximum weight of approx. 2 kg. The workpieces are for example of a metal material such as cast iron, aluminium or titan, or of a fibre-reinforced composite.

A machining installation where the workpiece holder pivot unit is designed in such a way that a first pivot member is arranged at the base frame so as to be pivotable about a vertical pivot axis ensures a large clearance for the workpiece holder, allowing a flexible use of the workpiece positioning device for picking up and depositing workpieces. Advantageously, the workpiece holder pivot unit is designed in such a way that the first pivot member is pivotable through 360° about the associated pivot axis. This ensures high flexibility when loading the machining installation with workpieces. The first pivot member of an industrial robot is also referred to as carousel.

A machining installation where the workpiece holder pivot unit is designed in such a way that the workpiece holder is pivotable about at least two, particularly about at least three horizontal pivot axes allows flexible positioning of the workpieces.

A machining installation where the workpiece holder pivot unit is designed in such a way that a second pivot member is arranged at a first pivot member so as to be pivotable about a horizontal second pivot axis; a third pivot member is arranged at the second pivot member so as to be pivotable about a horizontal third pivot axis; and a fourth pivot member is arranged at the third pivot member so as to be pivotable about a horizontal fourth pivot axis ensures a simple design. In an industrial robot, the pivot members are also referred to as robot arms or pivot aims.

A machining installation where the workpiece holder pivot unit is designed in such a way that the workpiece holder is pivotable about at least one pivot axis which is pivotable about a horizontal pivot axis and is not always horizontal allows flexible positioning of the workpieces. The pivot axis may for instance be perpendicular to the horizontal pivot axis so as to intersect said pivot axis, with the result that the workpiece holder is pivotable about its own axis. Furthermore, the pivot axis may be perpendicular to the horizontal pivot axis in such a way as to not intersect said pivot axis.

A machining installation where the workpiece holder pivot unit is designed in such a way that a fifth pivot member is arranged at a fourth pivot member so as to be pivotable about a fifth pivot axis, with the fifth pivot axis being perpendicular to a fourth pivot axis of the fourth pivot member has a simple design. The workpiece holder is arranged non-rotationally and detachably at the fifth pivot member.

A machining installation where the fifth pivot axis does not intersect the fourth pivot axis provides a simple manner of laterally machining the workpieces.

A machining installation where the workpiece holder is a workpiece gripper allows workpieces to be picked up and deposited automatically. The workpiece gripper is actuated for example hydraulically, pneumatically or by means of an electric motor.

A machining installation having a workpiece holder magazine for providing a plurality of different workpiece holders allows machining of different types of workpieces. To this end, different workpiece holders or workpiece grippers are provided in the workpiece holder magazine which can be changed automatically and without interruption using the workpiece positioning device. To this end, a first workpiece holder, which is detachably arranged at the workpiece holder pivot unit, is deposited in the workpiece holder magazine and a second workpiece holder for machining a new type of workpiece is detachably secured to the workpiece holder pivot unit. The second workpiece holder allows workpieces of a new type of workpiece to be machined continuously without having to stop the machining installation.

A machining installation where the stand comprises a first stand portion which is parallel to a vertical y-direction, with a second stand portion being arranged at said first stand portion that is inclined towards the workpiece positioning device ensures that a sufficiently large workspace is provided underneath the work spindle unit for positioning the workpieces.

A machining installation where the work spindle unit is arranged in a suspended manner ensures that chips produced during machining do not impair the work spindle unit.

A machining installation where a ratio of the mass m_{S} of the stand to the mass m_{P} of the workpiece positioning device is such that m_{S}/m_{P}≧2, particularly m_{S}/m_{P}≧3, and particularly m_{S}/m_{P}≧4, ensures a high machining accuracy. As the mass m_{S} of the stand is much higher than the mass m_{P} of the workpiece positioning device, vibrations during the machining of the workpieces are effectively prevented.

A machining installation where a tool changer unit comprising a tool magazine and a tool changer is arranged at the stand, particularly at the second stand portion, ensures a simple and quick change of tools. The tool changer is arranged between the work spindle unit and the tool magazine. The tool magazine is for example a disc magazine, with the tool holders being arranged or pivotable in such a way that the tools extend in the radial direction when performing a tool change.

A machining installation where the workpiece positioning device and the stand are arranged on a sub-frame into which a chip conveyor is integrated ensures on the one hand an accurate positioning of the workpiece positioning device and the work spindle unit relative to each other while allowing chips produced during machining to be carried off effectively.

A machining installation having at least one transport device for trans-porting workpieces to and away from the machining installation allows an automated transport of workpieces, which are to be machined or have already been machined, to or away from the machining installation.

Further features, advantages and details of the invention will become apparent from the ensuing description of an exemplary embodiment.

### BRIEF DESCRIPTION OF THE DRAWING

FIG. 1 shows a first perspective view of a machining installation comprising two transport devices;

FIG. 2 shows a first side view of the machining installation in FIG. 1 without the transport devices;

FIG. 3 shows a second perspective view of the machining installation in FIG. 1 without the transport devices; and

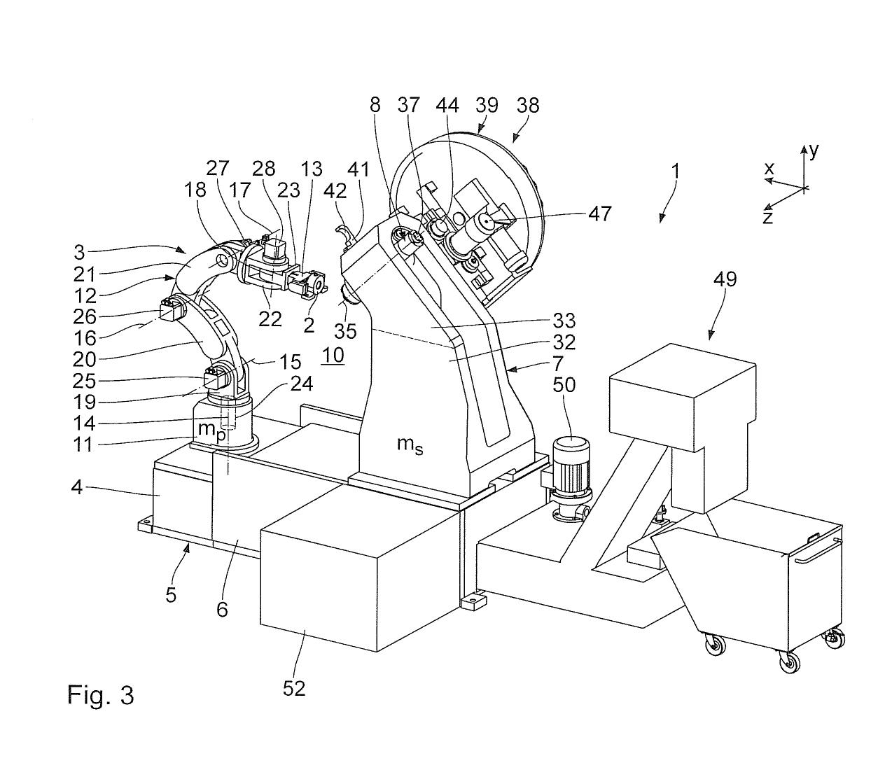

FIG. 4 shows a second side view of the machining installation in FIG. 1 without the transport devices.

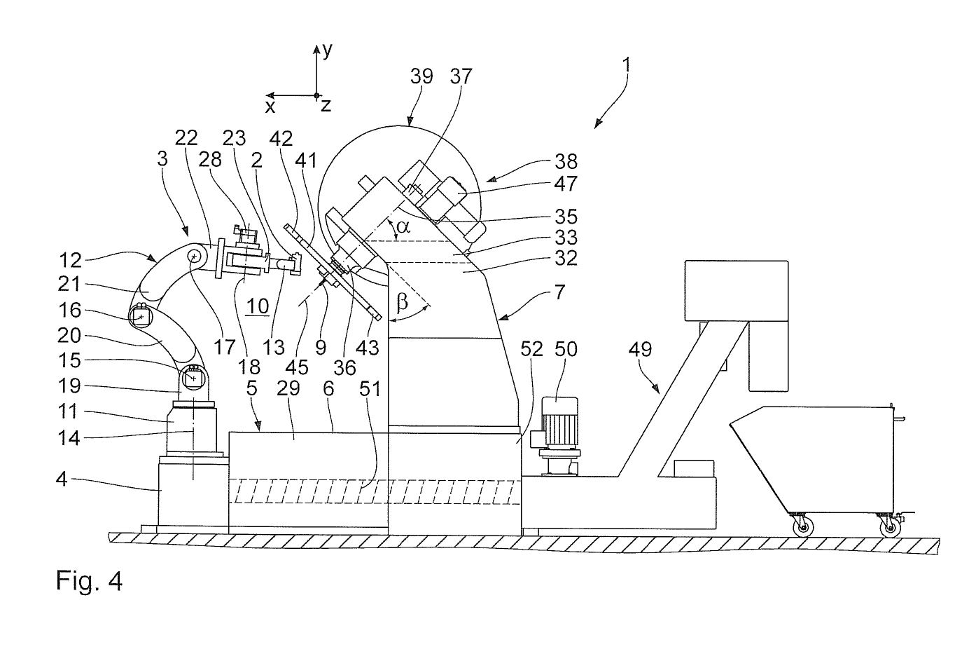

### DESCRIPTION OF THE PREFERRED EMBODIMENT

For machining workpieces 2, a machining installation 1 comprises a workpiece positioning device 3 which is arranged on a first sub-frame portion 4 of a sub-frame 5. A second sub-frame portion 6 is mounted to the first sub-frame portion 4, with a stand 7 provided with a work spindle unit 8 being arranged on said second sub-frame portion 6 for rotatably driving a tool 9. The stand 7 is spaced from the workpiece positioning device 3 in a horizontal x-direction, with the result that a workspace 10 is formed between the stand 7 and the workpiece positioning device 3. In the region of the workspace 10, the second sub-frame portion 6 has the shape of a tub for receiving chips produced during machining. The machining installation 1 is for example mounted to a base plate.

The workpiece positioning device 3 comprises a base frame 11 which is rigidly mounted to the first sub-frame portion 4. On the base frame 11, a workpiece holder pivot unit 12 is arranged by means of which a workpiece holder 13 is pivotable about five pivot axes 14 to 18.

The workpiece positioning device 3 is an industrial robot. In order to form the five pivot axes 14 to 18, the workpiece holder pivot unit 12 comprises five pivot members 19 to 23. A first pivot member 19 designed as a carousel is arranged about the vertical first pivot axis 14 in such a way as to be pivotable through 360° by means of a first drive motor 24. The first drive motor 24 is integrated into the base frame 11. The first pivot axis 14 is parallel to a vertical y-direction which is in turn perpendicular to the x-direction.

A second pivot member 20 designed as a robot arm or pivot arm is mounted to the first pivot member 19, the second pivot member 20 being pivotable about the horizontal second pivot axis 15 by means of a second drive motor 25. To this end, the end of the second pivot member 20 is pivotally connected to the first pivot member 19.

Correspondingly, a third pivot member 21 in the form of a pivot arm is arranged at the second pivot member 20, the third pivot member 21 being pivotable about the horizontal third pivot axis 16 by means of a third drive motor 26. To this end, the pivot members 20, 21 are pivotally interconnected at their ends.

A fourth pivot member 22 in the form of a pivot arm is arranged at the third pivot member 21, the fourth pivot member 22 being pivotable about the horizontal fourth pivot axis 17 by means of a fourth drive motor 27. To this end, the pivot members 21, 22 are pivotally interconnected at their ends.

A fifth pivot member 23 in the form of a pivot arm is arranged at the fourth pivot member 22, the fifth pivot member 23 being pivotable about a fifth pivot axis 18 by means of a fifth drive motor 28. The fifth pivot axis 18 is perpendicular to the fourth pivot axis 17 and does not intersect the fourth pivot axis 17. The pivot members 22, 23 are pivotally interconnected at their ends. The workpiece holder 13 is non-rotatably and detachably mounted to the free end of the pivot member 23. The workpiece holder 13 is a workpiece gripper and is actuable for example hydraulically, pneumatically or electromechanically.

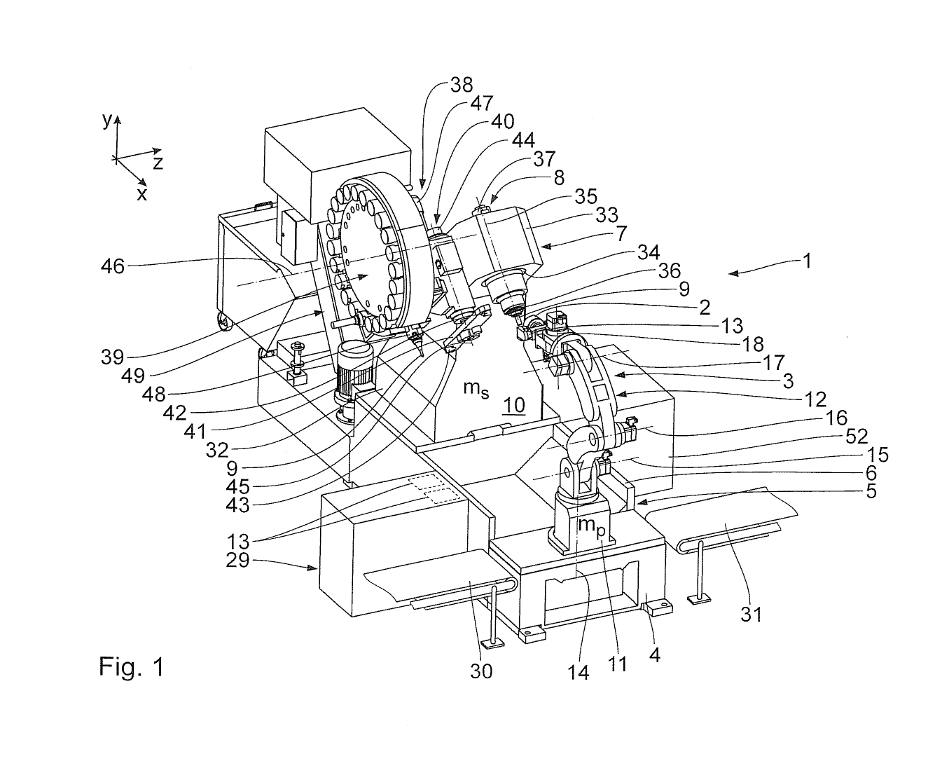

For changing the workpiece holder 13, the workpiece holder 13 is detachably mounted to the fifth pivot member 23. A workpiece holder magazine 29 is arranged at the side of the sub-frame 5 for providing different workpiece holders 13. The workpiece holders 13 are only outlined in FIG. 1.

In order to transport workpieces 2 to and away from the machining installation, two transport devices 30, 31 in the form of conveyor belts are provided which are arranged at both sides next to the first sub-frame portion 4 and extend in a horizontal z-direction. The z-direction is perpendicular to the x- and y-directions, with the result that a Cartesian coordinate system is formed.

The stand 7 comprises a first stand portion 32 which is substantially parallel to the y-direction and mounted to the sub-frame 5. A second stand portion 33 is formed in one piece with the first stand portion 32, the second stand portion 33 being inclined through an angle β relative to the y-direction. The second stand portion 33 has a bore 34 through which the work spindle unit 8 is guided in such a way that an axis of rotation 35 of the work spindle unit 8 is inclined towards the workpiece positioning device 3 through an angle α relative to the x-direction. The work spindle unit 8 is thus arranged in such a way as to be suspended at an angle. The angle α is equal to the angle β. The angle α is such that 20°≦α≦70°, particularly 30°≦α≦60°, and particularly 40°≦α≦50°. Preferably, the angle α is equal to 45°. The work spindle unit 8 comprises a chuck 36 for receiving the tool 9, the chuck 36 being drivable about the axis of rotation 35 by means of a spindle drive motor 37.

In order to damp vibrations during the machining of workpieces 2, the ratio of the mass m_{S} of the stand 7 to the mass M_{P} of the workpiece positioning device 3 is such that m_{S}/m_{P}≧2, particularly m_{S}/m_{P}≧3, and particularly m_{S}/m_{P}≧4.

At the side of the second stand portion 33, a tool changer unit 38 is arranged, the tool changer unit 38 comprising a tool magazine 39 and an associated tool changer 40. The tool changer 40 is arranged between the work spindle unit 8 and the tool magazine 39. The tool changer 40 comprises a changer arm 41 with two tool receptacles 42, 43, with the changer arm 41 being pivotable about a changer axis of rotation 45 by means of a changer drive motor 44. The changer axis of rotation 45 is parallel to the axis of rotation 35 of the work spindle unit 8.

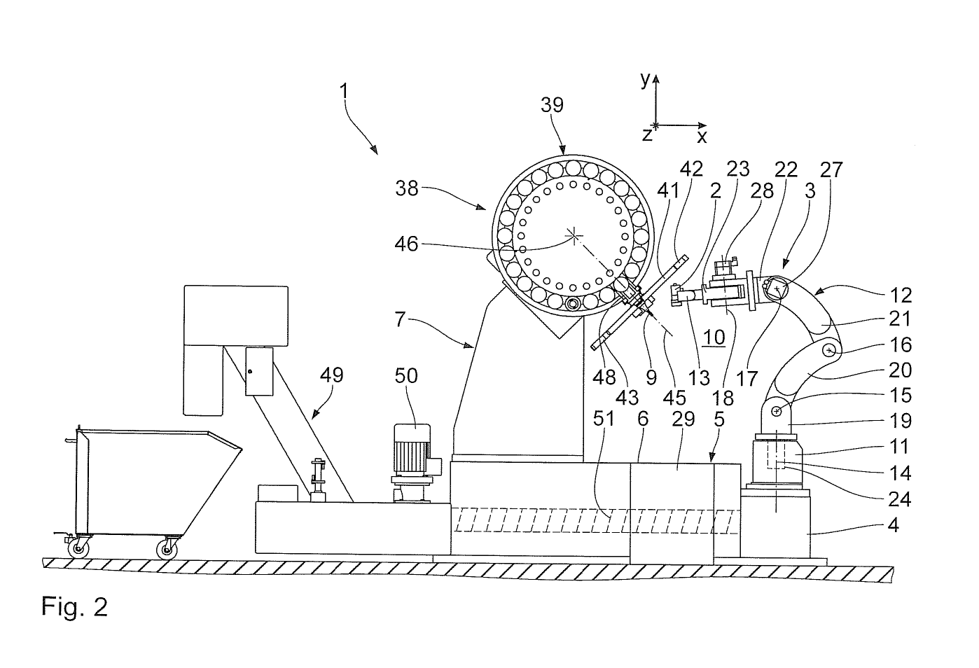

The tool magazine 39 is a disc magazine and is drivable about a magazine axis of rotation 46, which is parallel to the z-direction, by means of a magazine drive motor 47. The tool magazine 39 comprises a plurality of tool holders 48 which are arranged in a tool change position in such a way that the tools 9 received therein extend radially to the magazine axis of rotation 46. The tool change position is for example shown in FIG. 2.

In order to transport chips produced during machining away from the machining installation 1, a chip conveyor 49 is provided which comprises a screw conveyor 51 which is rotatably drivable using a conveyor drive motor 50. The chip conveyor 49 is arranged at a side of the second sub-frame portion 6 which is opposite to the workpiece positioning device 3, with the screw conveyor 51 extending into the second sub-frame portion 6. The screw conveyor 51 is only outlined in FIG. 2.

For controlling the machining installation 1, the drive motors 24 to 28, the transport devices 30, 31, the spindle drive motor 37, the changer drive motor 44, the magazine drive motor 47 and the conveyor drive motor 50 are connected to a control unit 52.

The workpieces 2 to be machined are transported to the machining installation 1 by means of the transport device 30. Having arrived at the machining installation 1, the workpiece holder 13 is pivoted toward the workpiece 2 using the workpiece holder pivot unit 12. The workpiece holder 13 seizes the workpiece 2 and is then pivoted to the work spindle unit 8 by means of the workpiece holder pivot unit 12 where it is positioned relative to the tool 9. To this end, the pivot members 19 to 23 comprise associated measuring sensors which measure the positions of adjacent pivoting members 19 to 23 relative to each other, allowing the workpiece 2 to be positionable in the absolute coordinate system (x-y-z coordinate system).

The workpiece 2 is now machined using the tool 9. To this end, the tool 9 is rotatably driven about the axis of rotation 35 by means of the spindle drive motor 37. The tool 9 is for example a milling or drilling tool. The chips produced during machining fall into the tub-shaped part of the second sub-frame portion 6 and are transported away using the screw conveyor 51.

The five pivot axes 14 to 18 of the workpiece positioning device 3 and the inclined arrangement of the work spindle unit 8 allow a five-sided machining of the workpiece 2. Due to the much higher mass m_{S} of the stand 7 compared to the mass m_{P} of the workpiece positioning device 3, vibrations during the machining of the workpiece 2 are effectively damped, with the result that a high machining accuracy is achieved.

The machined workpiece 2 is pivoted to the second transport device 31 using the workpiece holder pivot unit 12 where it is deposited using the workpiece holder 13. The transport device 31 transports the machined workpiece 2 away from the machining installation 1. Afterwards, the workpiece positioning device 3 is able to pick up, in the manner described above, a new workpiece 2 to be machined.

If the machining of workpieces 2 of a new type of workpiece requires a change of the workpiece holder 13, then the workpiece holder pivot unit 12 moves the workpiece holder 13 to the workpiece holder magazine 29 where it deposits the workpiece holder 13. The workpiece holder 13 is detached from the fifth pivot member 23 using hydraulic, pneumatic or electromechanical means. Afterwards, the workpiece holder pivot unit 12 moves to a new workpiece holder 13 by means of which the workpieces 2 of the new type of workpiece are sizable. The new workpiece holder 13 is coupled to the fifth pivot member 23. Afterwards, the workpiece holder pivot unit 12 moves the workpiece holder 13 to the first transport device 30 where a workpiece 2 of the new type of workpiece is picked up. Machining continues in the manner described above.

In order to change tools, the tool magazine 39 is pivoted about the magazine axis of rotation 46 until the desired tool 9 is in the tool change position shown in FIG. 1. In the tool change position, the tool changer 48 is pivoted in such a way that the tool 9 to be changed extends radially to the magazine axis of rotation 46. Afterwards, the changer arm 41 is pivoted in the clockwise direction using the changer drive motor 44 so that the tool receptacle 42 receives the tool 9 disposed in the chuck 36 and the tool receptacle 43 receives the tool 9 disposed in the tool holder 48. Afterwards, the changer arm 41 is displaced linearly in the direction of the changer axis of rotation 45 so that the tools 9 are removed. The changer arm 41 is then pivoted through 180° using the changer drive motor 44 and displaced linearly in the direction of the changer axis of rotation 45 again so that the changed tools 9 are received in the chuck 36 and in the tool holder 48. Afterwards, the changer arm 41 is pivoted back in its initial position so that machining of the workpiece 2 may continue with the changed tool 9.

The machining installation 1 is particularly suitable for machining of workpieces 2 of metal and/or of workpieces 2 of a fibre-reinforced composite.

What is claimed is:

1. A machining installation for workpieces, comprising
a workpiece positioning device for positioning a workpiece to be machined, comprising
a base frame;
a workpiece holder; and
a workpiece holder pivot unit which is arranged between the base frame and the workpiece holder and is designed in such a way that the workpiece holder is pivotable about at least five pivot axes;
a work spindle unit for rotatably driving a tool about an axis of rotation, the work spindle unit being arranged at a stand in such a way that the axis of rotation is inclined through an angle α relative to a horizontal x-direction, with 20°≦α≦70°.

2. A machining installation for workpieces according to claim 1, wherein the angle α of the axis of rotation relative to the horizontal x-direction is such that 30°≦α≦60°.

3. A machining installation for workpieces according to claim 1, wherein the angle α of the axis of rotation relative to the horizontal x-direction is such that 40°≦α≦50°.

4. A machining installation according to claim 1, wherein the workpiece holder pivot unit is designed in such a way that a first pivot member is arranged at the base frame so as to be pivotable about a vertical pivot axis.

5. A machining installation according to claim 1, wherein the workpiece holder pivot unit is designed in such a way that the workpiece holder is pivotable about at least two horizontal pivot axes.

6. A machining installation according to claim 5, wherein the workpiece holder is pivotable about at least three horizontal pivot axes.

7. A machining installation according to claim 1, wherein the workpiece holder pivot unit is designed in such a way that
a second pivot member is arranged at a first pivot member so as to be pivotable about a horizontal second pivot axis;
a third pivot member is arranged at the second pivot member so as to be pivotable about a horizontal third pivot axis; and
a fourth pivot member is arranged at the third pivot member so as to be pivotable about a horizontal fourth pivot axis.

8. A machining installation according to claim 1, wherein the workpiece holder pivot unit is designed in such a way that the workpiece holder is pivotable about at least one pivot axis which is pivotable about a horizontal pivot axis and is not always horizontal.

9. A machining installation according to claim 1, wherein the workpiece holder pivot unit is designed in such a way that a fifth pivot member is arranged at a fourth pivot member so as to be pivotable about a fifth pivot axis, with the fifth pivot axis being perpendicular to a fourth pivot axis of the fourth pivot member.

10. A machining installation according to claim 9, wherein the fifth pivot axis does not intersect the fourth pivot axis.

11. A machining installation according to claim 1, wherein the workpiece holder is a workpiece gripper.

12. A machining installation according to claim 1, comprising a workpiece holder magazine for providing a plurality of different workpiece holders.

13. A machining installation according to claim 1, wherein the stand comprises a first stand portion which is parallel to a vertical y-direction, with a second stand portion being arranged at said first stand portion that is inclined towards the workpiece positioning device.

14. A machining installation according to claim 1, wherein the work spindle unit is arranged in a suspended manner.

15. A machining installation according to claim 1, wherein a ratio of the mass m_{S} of the stand to the mass m_{P} of the workpiece positioning device is such that m_{S}/m_{P}≧2.

16. A machining installation according to claim 1, wherein a ratio of the mass m_{S} of the stand to the mass m_{P} of the workpiece positioning device is such that m_{S}/m_{P}≧3.

17. A machining installation according to claim 1, wherein a ratio of the mass m_{S} of the stand to the mass m_{P} of the workpiece positioning device is such that m_{S}/m_{P}≧4.

18. A machining installation according to claim 1, wherein a tool changer unit comprising a tool magazine and a tool changer is arranged at the stand.

19. A machining installation according to claim 18, wherein the tool changer unit is arranged at the second stand portion.

20. A machining installation according to claim 1, wherein the workpiece positioning device and the stand are arranged on a sub-frame into which a chip conveyor is integrated.

21. A machining installation according to claim 1, comprising at least one transport device for transporting workpieces to and away from the machining installation.
